(19) United States
(12) Patent Application Publication
(10) Pub. No.: US 2007/0270992 A1
(43) Pub. Date: Nov. 22, 2007

(54) Monitoring Method, Monitoring Apparatus, and Mounter

(76) Inventors: Hiroyoshi Nishida, Yamanashi (JP); Kazuhiko Itose, Fukuoka (JP)

Correspondence Address: WENDEROTH, LIND & PONACK L.L.P., 2033 K. STREET, NW, SUITE 800, WASHINGTON, DC, 20006, US

(21) Appl. No.: 11/663,762

(22) PCT Filed: Jul. 19, 2006
(86) PCT No.: PCT/JP06/01168

§ 371 Date: Mar. 26, 2007

(30) Foreign Application Priority Data
Jan. 27, 2005 (JP) 2005-019206
Mar. 31, 2005 (JP) 2005-104110

(51) Int. Cl. G06F 19/00

(52) U.S. Cl. 700/111; 700/108; 700/99; 700/100

(57) ABSTRACT

The monitoring method, which is capable of improving the efficiency in producing component mounting boards at the whole production line level, is a monitoring method of monitoring an operating status of a production line for producing a component mounting board by mounting components onto a board, the method including: a monitoring step (S302) of monitoring an operating status of each of production apparatuses making up the production line; and a controlling step (S304 to S306) of performing a control that allows each of one or more mounters, included in the production apparatuses making up the production line, to efficiently produce the component mounting board, based on a result of the monitoring step (S302).

### TECHNICAL FIELD

The present invention relates to a monitoring method, and particularly to a monitoring method of monitoring the operating status of each of a plurality of production apparatuses making up a production line for producing component mounting boards.

### BACKGROUND ART

Conventionally, in a production line in which a plurality of production apparatuses such as a mounter are placed, various states of the production apparatuses are assessed on a production apparatus basis, and a control is performed accordingly only on each production apparatus subjected to assessment.

In recent years, for example, there has been proposed a mounter that produces component mounting boards by mounting components onto boards while frequently controlling power supply for the purpose of energy saving (e.g., refer to Japanese Laid-Open Patent Application No. 2003-264399). Such mounter controls power supply and interruption of power supply to the processing units of the mounter, by autonomously assessing a current state of each of such processing units, such as whether the processing unit is in a wait state or in a halt state for operation. This mounter promotes energy saving in this manner.

Meanwhile, materials such as solder and adhesive necessary for producing component mounting boards are subject to quality deterioration due to oxidation or the like, unless they are consumed within a certain period of time after their packages are opened. Such quality degradation of materials such as solder leads to defects of component mounting boards as well as to decrease in yield. Components such as Ball Grid Arrays (BGAs) that require baking need to be baked again unless they are consumed within a certain period of time after their packages are opened. Thus, the use of components whose expiration data has expired also leads to defects of component mounting boards as well as to decrease in yield. Conventionally, in order to prevent such defects of component mounting boards, the management of the expiration dates of materials to be used, such as solder, adhesive, and BGAs, has been conducted by human hand.

Furthermore, in a production line for producing boards or the like, it is important how the productivity can be increased without stopping the production line as much as possible. In view of this, there has been proposed a component-lack advance notice apparatus that provides an operator with an advance notice of when there occurs a lack of components to be mounted onto boards, and displays such advance notice (e.g., Japanese Laid-Open Patent Application No. 2000-244184).

However, a conventional mounter that aims at promoting energy saving accomplishes it by autonomously assessing various states of its processing units. For this reason, in the case where a board is newly transported to such conventional mounter while power supply is interrupted, the mounter needs to start supplying power to processing units required for board production so as to start mounting components onto the board. However, it takes a certain length of time for each processing unit to enter a stable state after power supply starts. This causes a problem of poor production efficiency since component mounting cannot be carried out during such certain length of time, although the board has been arrived, ready for component mounting. In other words, since the conventional mounter focuses only on the fact of whether or not there is a board being transported into the mounter without focusing on the transportation of a board to another mounter, there is a problem of a time delay between the mounters in the control of operating or not-operating the mounters.

Furthermore, since it is a heavy burden on an operator of a mounter to have to manage the expiration dates of materials and components, there occurs a problem of quality degradation if such operator carelessly uses components whose expiration date has expired to produce component mounting boards.

Moreover, according to the conventional component-lack advance notice apparatus, while it is possible to make an advance notice of when a lack of components will occur, such apparatus does not show an order in which component replacement should be carried out.

If component replacement were carried out starting from components which become out of stock earlier than others, such component replacement order is not necessarily the optimum one. This is because, other than the components, the production line uses various materials, such as solder and adhesive, which require replacement and which take respectively different length of time to be replaced. Furthermore, since such materials are placed at dispersed different storage sites, the time required to replace materials differs depending on the position of the operator who replaces materials.

Thus, if the component replacement is carried out in the above replacement order, it leads to a possible problem of longer downtime of each of apparatuses such as a mounter making up the production line. In other words, according to the conventional component-lack advance notice apparatus, while it is possible to make an advance notice of when a lack of components of each feeder will occur at a single mounter level, such conventional apparatus has a problem of not being able to provide a countermeasure that allows the extraction of timings at which there occurs a lack of components at the whole production line level, and that minimizes an operational loss in the production line attributable to a lack of components based on such extracted timings.

### DISCLOSURE OF INVENTION

The present invention has been conceived in view of the above-mentioned problems, and it is an object of the present invention to provide a monitoring method and the like that are capable of improving the efficiency in producing component mounting boards in a production line at the whole production line level.

It is another object of the present invention to provide a monitoring method and the like that are capable of promoting energy saving of each of the production apparatuses such as a mounter that make up the production line, without decreasing the efficiency in producing component mounting boards and without causing quality degradation.

It is further another object of the present invention to provide a monitoring method or the like that are capable of determining a material replacement order that reduces the downtime of each of the apparatuses making up the production line.

In order to achieve the above objects, the monitoring method according to the present invention is a monitoring method of monitoring an operating status of a production line for producing a component mounting board by mounting components onto a board, the method including: monitoring an operating status of each of production apparatuses making up the production line; and performing a control that allows each of one or more mounters, included in the production apparatuses making up the production line, to efficiently produce the component mounting board, based on a result of the monitoring.

With the above structure, it is possible to: perform such a control as improves the production efficiency of another mounter, based on the operating status of each of the production apparatuses making up the production line; perform such a control as improves the production efficiency of plural mounters, based on the operating status of each of such plural mounters; and the like. By performing such a control as improves the production efficiency of a mounter that is different from production apparatuses subjected to monitoring, or by performing such a control as improves the production efficiency of plural mounters, it is possible to improve the production efficiency at the whole production line level.

Preferably, in the monitoring, the operating status of at least one of the production apparatuses is monitored, and the performing of the control includes causing one or more of the mounters to enter an operating state or a non-operating state based on the result of the monitoring, each of one or more of the mounters being different from the production apparatus subjected to the monitoring.

With the above structure, the operating status of one production apparatus is utilized for controlling the operating status of another mounter. As a result, it is possible to predict the timing at which a board arrives at such another mounter, and thus to determine the timing for powering on a production apparatus so that the power state or the like of such production apparatus is stable when a board arrives at the production apparatus. This makes it possible to promote energy saving of each mounter without reducing the efficiency in producing component mounting boards.

Note that in addition to a mounter that mounts components onto a board, the mounters whose operating status is subjected to monitoring may include: a solder printer that prints solder onto a board; an adhesive dispenser that applies adhesive onto a board; a reflow furnace that melts the solder or the like by heating boards on which components have been mounted, and then fixing the components to the respective boards; and the like.

More preferably, the above monitoring method further includes monitoring a material or a component, used for producing the component mounting board, whose expiration date needs to be managed, and outputting a warning in the case where a predetermined period of time has elapsed after the use of the material or component starts.

With the above structure, a warning is outputted in the case where a predetermined period of time has elapsed after the use of the material or component starts. This makes it possible to manage the expiration dates of materials and components without relying on the management by human hands, and consequently to improve the quality of component mounting boards since there occur fewer possibilities that component mounting boards are produced by use of components whose expiration date has expired.

More preferably, the monitoring includes: extracting a plurality of depletion occurrence points in the production line, each of the depletion occurrence points being a point for which an advance notice is given indicating that material depletion is approaching; and identifying, from the depletion occurrence points, a lowest depletion occurrence point that is located at a lowest stream in the production line, and the performing of the control includes determining a material replacement order by determining a travel route that allows an operator to first arrive at a material storage site corresponding to the lowest depletion occurrence point, and then to travel the other depletion occurrence points and material storage sites corresponding to the respective depletion occurrence points, the material replacement order being an order in which the operator replaces materials at the respective depletion occurrence points while traveling along the determined travel route.

With the above structure, it is possible to replace materials located at the lowest stream in the production line first of all. As a result, there will be no products staying at the lowest stream, which consequently results in improved production efficiency and reduced downtime.

More preferably, the monitoring includes extracting a plurality of depletion occurrence points in the production line, each of the depletion occurrence points being a point for which an advance notice is given indicating that material depletion is approaching, and the performing of the control includes determining a material replacement order by determining a travel route with a shortest necessary time, the travel order allowing an operator to travel the depletion occurrence points and material storage sites corresponding to the respective depletion occurrence points, and to supply materials at the respective depletion occurrence points in the shortest time, the material replacement order being an order in which the operator replaces the materials at the respective depletion occurrence points while traveling along the determined travel route.

With this structure, a material replacement order is determined that allows materials to be replaced in the shortest time. This makes it possible to provide a method of determining a material replacement order that reduces the downtime of each of the apparatuses making up the production line.

More preferably, in the determining of the material replacement order, the material replacement order with a largest number of materials is determined, the number of materials being a number of materials, each of which requires a shorter period of time to complete material replacement than a material depletion grace time that is a period of time from when the advance notice is given to when material depletion actually occurs.

With this structure, a material replacement order is determined that allows material replacement to complete during a period of time from when an advance notice indicating material depletion is given to when the material depletion actually occurs. This makes it possible to provide a method of determining a material replacement order that reduces the downtime of each of the apparatuses making up the production line without stopping the operation of each of such apparatuses as much as possible.

More preferably, in the determining of the material replacement order, the material replacement order is determined by integrating material storage sites whose distance from each other is not greater than a predetermined threshold value, out of the material storage sites corresponding to the materials to be supplied to the respective depletion occurrence points, and then by determining the travel route with a shortest travel distance or a shortest travel time, the travel route allowing the operator to travel material storage sites that remain after the integration.

By integrating material storage sites not distant from each other, the operator can take out plural types of materials from material storage sites and replace plural types of materials at one time. As a result, a return travel time to travel between a material storage site and a depletion occurrence point is reduced. This makes it possible to provide a method of determining a material replacement order that reduces the time required for material replacement and that reduces the downtime of each of the apparatuses making up the production line without stopping the operation of each of such apparatuses as much as possible.

Note that it is not only possible to embody the present invention as the above-described monitoring method including the characteristic steps, but also as a monitoring apparatus that includes, as its units, the characteristic steps included in the above monitoring method, and as a program that causes a computer to execute the characteristic steps included in the above monitoring method. It should be also noted that such program can be distributed on a storage medium such as a compact disc-read only memory (CD-ROM) as well as over a communication network such as the Internet.

As described above, the present invention is capable of providing a monitoring method and the like that are capable of improving the efficiency in producing component mounting boards in a production line at the whole production line level.

The present invention is also capable of providing a monitoring method and the like that are capable of promoting energy saving of each of the production apparatuses such as a mounter that make up the production line, without decreasing the efficiency in producing component mounting boards and without causing quality degradation.

The present invention is also capable of providing a monitoring method and the like that are capable of determining a material replacement order that reduces the downtime of each of the apparatuses making up the production line.

### FURTHER INFORMATION ABOUT TECHNICAL BACKGROUND TO THIS APPLICATION

The disclosure of Japanese Patent Application No. 2005-104110 filed on Mar. 31, 2005, and the disclosure of Japanese Patent Application No. 2005-19206 filed on Jan. 27, 2005, including specification, drawings and claims are incorporated herein by reference in its entirety.

### BRIEF DESCRIPTION OF DRAWINGS

These and other objects, advantages and features of the invention will become apparent from the following description thereof taken in conjunction with the accompanying drawings that illustrate a specific embodiment of the invention. In the Drawings:

FIG. 1 is an external view showing the structure of a component mounting system;

FIG. 2 is a functional block diagram showing the structure of a line manager;

FIG. 3 is a flowchart showing processes performed by the line manager on production apparatuses making up a production line;

FIG. 4 is a block diagram showing major constituent elements of a mounter that are related to energy saving;

FIG. 5 is a functional block diagram showing the structure of the line manager;

FIG. 6 is a diagram showing information collected by the line manager from each of the production apparatuses;

FIG. 7 is a diagram for describing processes performed by the line manager;

FIG. 8 is a flowchart showing processes performed by the line manager on an arbitrary production apparatus;

FIG. 9 is a diagram showing an operating status of the production line to be displayed on a screen;

FIG. 10 is an external view showing an overall structure of the component mounting system;

FIG. 11 is a block diagram showing an internal structure of a material replacement order determination apparatus;

FIG. 12 is a diagram showing an example of a component feeder that holds one type of components mounted by each mounter;

FIG. 13 is a diagram showing an example of an operation panel;

FIG. 14 is a table that summarizes points to be noted to improve the efficiency of material replacement;

FIG. 15 is a table that summarizes various points used in processes of determining a material replacement order and symbols indicating the respective points;

FIG. 16 is a table showing the time and travel distance required for material replacement on a material type basis;

FIG. 17 is a flowchart showing processes of determining a material replacement order;

FIG. 18 is a diagram showing depletion occurrence points for which advance notices indicating material depletion are given as well as showing a material replacement order;

FIG. 19 is a diagram showing a travel distance of the operator;

FIG. 20 is a diagram showing a material replacement order;

FIG. 21 is a table that summarizes a total necessary time and process completion times required for material replacement;

FIG. 22 is a table that summarizes a total necessary time and process completion times required for material replacement;

FIG. 23 is a diagram showing a material replacement order;

FIG. 24 is a table that summarizes a total necessary time and process completion times required for material replacement;

FIG. 25 is a diagram showing a material replacement order; and

FIG. 26 is a diagram showing the final material replacement order to be displayed on the display of an information output apparatus.

### BEST MODE FOR CARRYING OUT THE INVENTION

The following describes a component mounting system according to embodiments of the present invention with reference to the drawings.

### First Embodiment

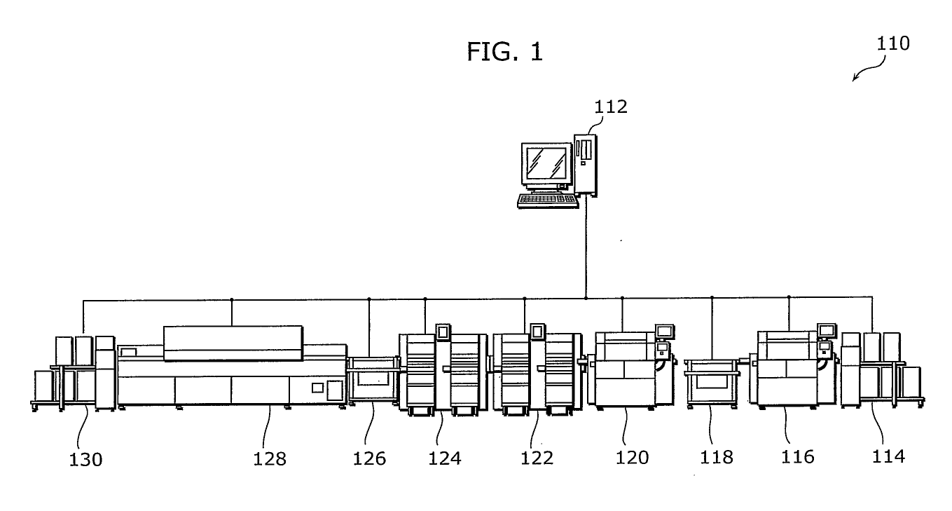

FIG. 1 is an external view showing the structure of the component mounting system according to the first embodiment of the present invention.

The component mounting system 110 is a system for producing component mounting boards on which components are mounted by transporting each board from upstream to downstream production apparatuses. The component mounting system 110 is comprised of stockers 114 and 130, a solder printer 116, conveyors 118 and 126, an adhesive dispenser 120, mounters 122 and 124, a reflow furnace 128, and a line manager 112.

The stockers 114 and 130 are apparatuses, each stocking boards. In the production line, the stocker 114 is located at the uppermost stream and the stocker 130 is located at the lowest stream. In other words, the stocker 114 stocks boards on which components have not yet been mounted, whereas the stocker 130 stocks completed component mounting boards on which components have been mounted.

The solder printer 116 is an apparatus that prints solder paste onto a board. The conveyors 118 and 126 are apparatuses, each transporting a board. The adhesive dispenser 120 is an apparatus that applies adhesive onto a board. The mounters 122 and 124 are apparatuses, each mounting components onto a board. The reflow furnace 128 is an apparatus that melts the solder or the like by heating boards on which components have been mounted, and then fixing the components to the respective boards.

Solder and adhesive respectively used by the solder printer 116 and the adhesive dispenser 120 require the management of the expiration dates. Some of materials used by the mounters 122 and 124, such as BGAs, require the management of the expiration dates.

The line manager 112, which is connected to all of the above-mentioned production apparatuses making up the production line, is an apparatus that controls the power supply by allowing or interrupting the power supply to the respective production apparatuses.

Note that the line manager 112 and each of the production apparatuses are connected via a communication means such as the Ethernet (registered trademark), RS232C, and a remote I/O.

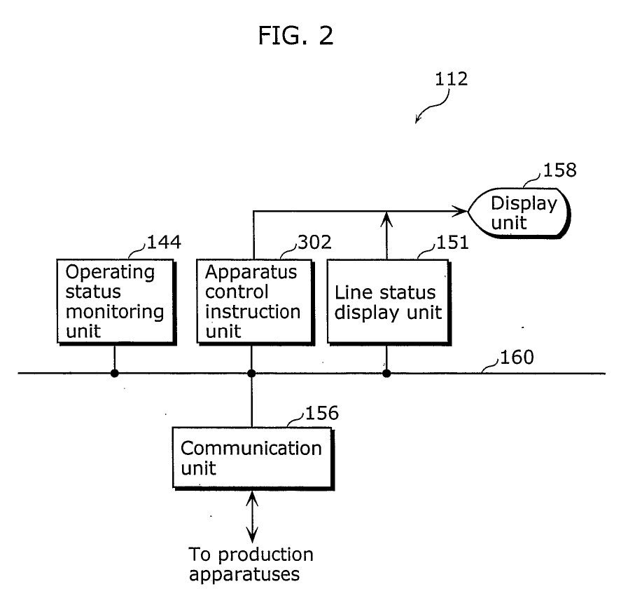

FIG. 2 is a functional block diagram showing the structure of the line manager 112.

The line manager 112 is a processing apparatus that controls the production apparatuses making up the production line by causing it to operate or not to operate. The line manager 112 includes an operating status monitoring unit 144, an apparatus control instruction unit 302, a line status display unit 151, a communication unit 156, a display unit 158, and a bus 160.

The communication unit 156 is a processing unit that communicates with each of the production apparatuses making up the production line.

The operating status monitoring unit 144 is a processing unit that monitors the operating status of each of the production apparatuses.

The apparatus control instruction unit 302 is a processing unit that performs such a control as enables each of the production apparatuses making up the production line to efficiently produce component mounting boards, based on the operating status of each of the production apparatuses monitored by the operating status monitoring unit 144. The processes performed by the apparatus control instruction unit 302 includes: causing the display unit 158 to display the details of controls performed on each of the production apparatuses; notifying each of the production apparatuses of the details displayed by the display unit 158 via the communication unit 156; and the like.

The line status display unit 151 is a processing unit that causes the below-described display unit 158 to display the operating state of each of the production apparatuses in the production line.

The display unit 158 is a display screen that displays thereon an operating state, a warning, control details, and the like.

The bus 160 is a signal line that interconnects each of the processing units making up the line manager 112.

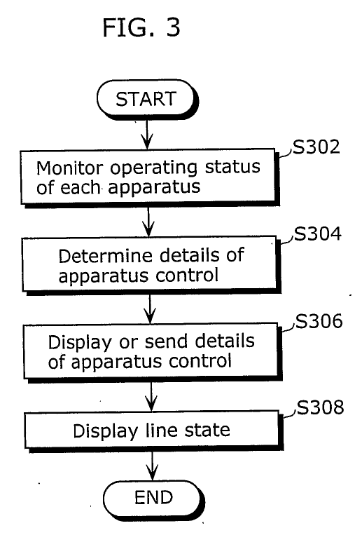

FIG. 3 is a flowchart showing processes performed by the line manager 112 on the production apparatuses making up the production line.

The operating status monitoring unit 144 monitors the operating status of each production apparatus (S302). Note that production apparatuses to be monitored may be all the production apparatuses making up the production line or may be one or more specific production apparatuses.

The apparatus control instruction unit 302 determines such details of controls as enable each of the production apparatuses making up the production line to efficiently produce component mounting boards, based on the monitoring result obtained by the operating status monitoring unit 144 (S304). Note that production apparatuses to be controlled may be determined in advance or may be determined based on the monitoring result.

The apparatus control instruction unit 302 causes the display unit 158 to display the determined control details (S306). Alternatively, the apparatus control instruction unit 302 sends the control details to each of the production apparatus to be controlled via the communication unit 156 (S306). Each production apparatus, which has received the control details, performs a necessary process based on the received control details.

The line status display unit 151 causes the display unit 158 to display the operating state of each of the production apparatuses in the production line (S308).

As described above, according to the first embodiment, it is possible to: perform such a control as improves the production efficiency of another mounter, based on the operating status of each of the production apparatuses making up the production line; perform such a control as improves the production efficiency of plural mounters, based on the operating statues of such plural mounters; and the like. By performing such a control as improves the production efficiency of a mounter that is different from production apparatuses being monitored, or by performing such a control as improves the production efficiency of plural mounters, it is possible to improve the production efficiency at the whole production line level.

### Second Embodiment

Next, a description is given of the component mounting system according to the second embodiment of the present invention. The second embodiment provides a more concrete description of the component mounting system presented in the first embodiment.

The structure of the component mounting system according to the second embodiment is the same as the one shown in FIG. 1, and thus a detailed description thereof is not repeated here.

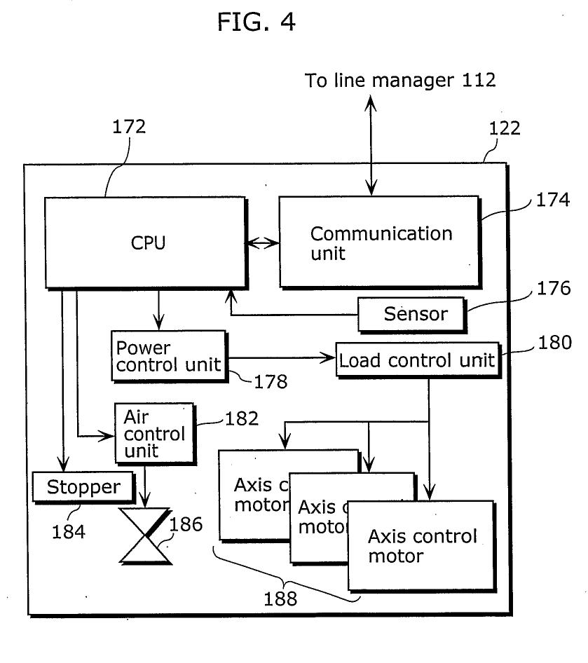

FIG. 4 is a block diagram showing major constituent elements of the mounter 122 that are related to energy saving.

The mounter 122 includes, as major constituent elements thereof, a central processing unit (CPU) 172, a communication unit 174, sensors 176, a power control unit 178, a load control unit 180, an air control unit 182, a stopper 184, an electromagnetic valve 186, and axis control monitors 188.

The communication unit 174 is a processing unit that communicates with the line manager 112. The CPU 172 is a processing unit that communicates with the line manager 112 via the communication unit 174 and gives an instruction to each of the below-described processing units.

The sensors 176, which are equipped at a position from which a boards is transported into the mounter 122 (hereinafter also referred to as the “board incoming position”) and at a position from which a board is transported out from the mounter 122 (hereinafter also referred to as the “board outgoing position”), detect that a board has been transported into and out from the mounter 122, respectively. The sensors 176 function as a monitoring means for monitoring the operating status of each of the production apparatuses.

The stopper 184, which is equipped at the board incoming position of the mounter 122, is an apparatus that stops a board from being transported into the mounter 122 under abnormal circumstances.

The electromagnetic valve 186 is an apparatus that adjusts the flow of air to be used when the mounter 122 vacuum-sucks electronic components by pickup nozzles (not illustrated in the drawing) and mounts the components onto a board utilizing air pressure. The air control unit 182 is an apparatus that controls the opening/closing of the electromagnetic valve 186.

Each of the axis control monitors 188 is a monitor for moving a pickup head (not illustrated in the drawing) having plural pickup nozzles in the respective axis directions. The load control unit 180 is a processing unit that controls the number of rotations, the rotational directions of each of the axis control motors 188, and the like. The power control unit 178 is a processing unit that controls whether or not to supply power to the load control unit 180.

Out of the constituent elements of the mounter 122, the CPU 172, the communication unit 174, and the sensors 176 are activated at all times, while the other processing units need to be activated based on an instruction from the CPU 172. The other production apparatuses that make up the production line shown in FIG. 1 also have the same constituent elements as shown in FIG. 4.

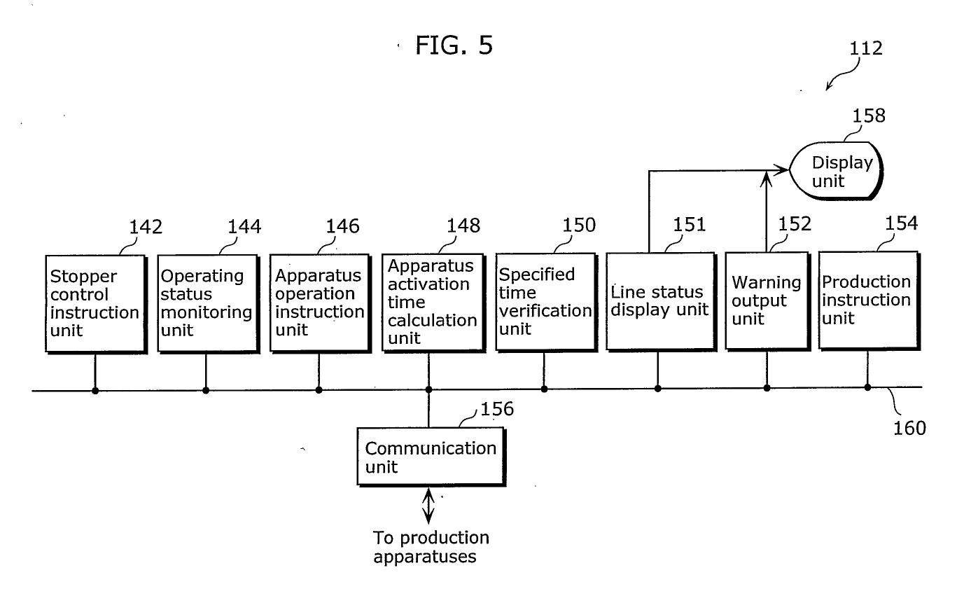

FIG. 5 is a functional block diagram showing the structure of the line manager 112. Each of the units included in the line manager 112 functions as an operation control means for controlling the respective production apparatuses by causing them to operate or not to operate.

FIG. 5 shows a more detailed structure of the line manager 112 shown in FIG. 2.

The line manager 112 includes a stopper control instruction unit 142, an operating status monitoring unit 144, an apparatus operation instruction unit 146, an apparatus activation time calculation unit 148, a specified time verification unit 150, a line status display unit 151, a warning output unit 152, a production instruction unit 154, a communication unit 156, a display unit 158, and a bus 160.

The communication unit 156 is a processing unit that communicates with each of the production apparatuses making up the production line.

The stopper control instruction unit 142 is a processing unit that sends, via the communication unit 156, an instruction for controlling the stopper 184 of each of the production apparatuses.

The operating status monitoring unit 144 is a processing unit that monitors the operating status of each of the production apparatuses.

The apparatus operation instruction unit 146 is a processing unit that sends, to each of the production apparatuses, an instruction to operate or not to operate it via the communication unit 156.

The apparatus activation time calculation unit 148 is a processing unit that calculates, for each of the production apparatuses, an apparatus activation time that is the time at which the production apparatus is activated. Note that the apparatus activation time calculation unit 148 may calculate a period of time or timing in which each of the production apparatuses is activated, instead of the time at which each of the production apparatuses is activated. For example, the apparatus activation time calculation unit 148 may calculate timing or the like indicating how many minutes after the current time each production apparatus should be activated.

The specified time verification unit 150 is a processing unit that verifies whether or not the current time is within a specified period of time after opening the package of material/components, such as solder, adhesive, and, that require the management of the expiration periods.

The line status display unit 151 is a processing unit that causes the below-described display unit 158 to display the operating state of each of the production apparatuses in the production line.

The warning output unit 152 is a processing unit that outputs a warning in the case where the specified time verification unit 150 judges that the current time is beyond a specified period of time. The display unit 158 is a display screen that displays thereon an operating state and a warning, and the like.

The production instruction unit 154 is a processing unit that sends, to each of the production apparatuses, an instruction to start the production via the communication unit 156.

The bus 160 is a signal line that interconnects each of the processing units making up the line manager 112.

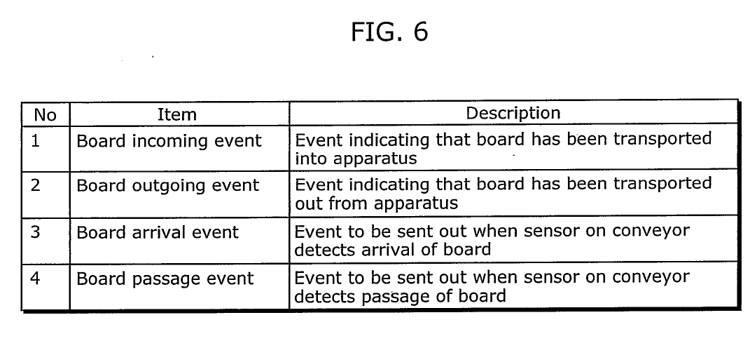

FIG. 6 is a diagram showing information collected by the line manager 112 from each of the production apparatuses.

The line manager 112 collects, from each of the production apparatuses, the following pieces of information respectively indicating four events: “board incoming event”; “board outgoing event”; “board arrival event”; and “board passage event”.

The “board incoming event” is an event indicating that a board has transported into a production apparatus except for the stockers 114 and 130 as well as the conveyors 118 and 126. Each production apparatus sends this event to the line manager 112 in the case where the sensor 176 equipped to such production apparatus detests that a board has been transported thereto.

The “board outgoing event” is an event indicating that a board has been transported out from a production apparatus except for the stockers 114 and 130 as well as the conveyors 118 and 126. Each production apparatus sends this event to the line manager 112 in the case where the sensor 176 equipped to such production apparatus detests that a board has been transported therefrom.

The “board arrival event” is an event that is sent out to the line manager 112 in the case where the sensor 176 equipped to the conveyor 118 or 126 detects that a board has arrived.

The “board passage event” is an event that is sent out to the line manager 112 in the case where the sensor 176 equipped to the conveyor 118 or 126 detects that a board has passed through.

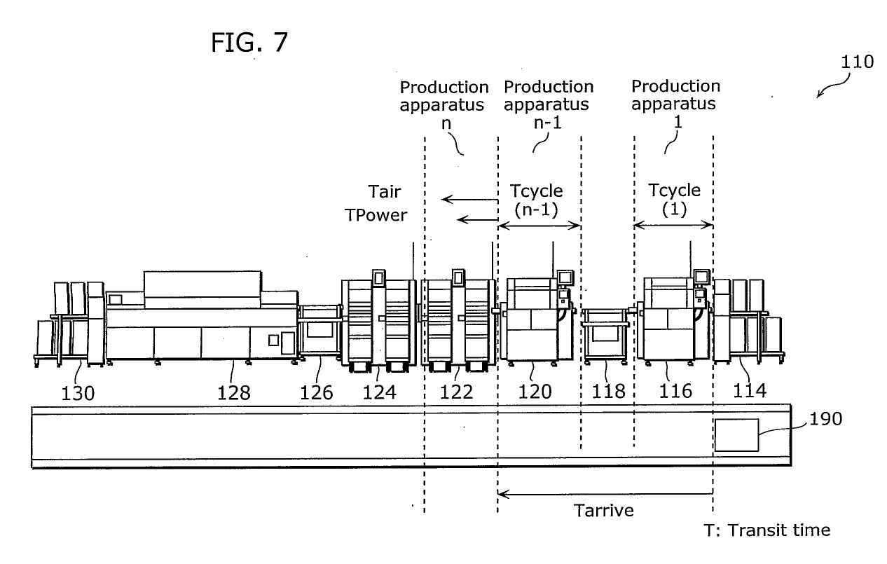

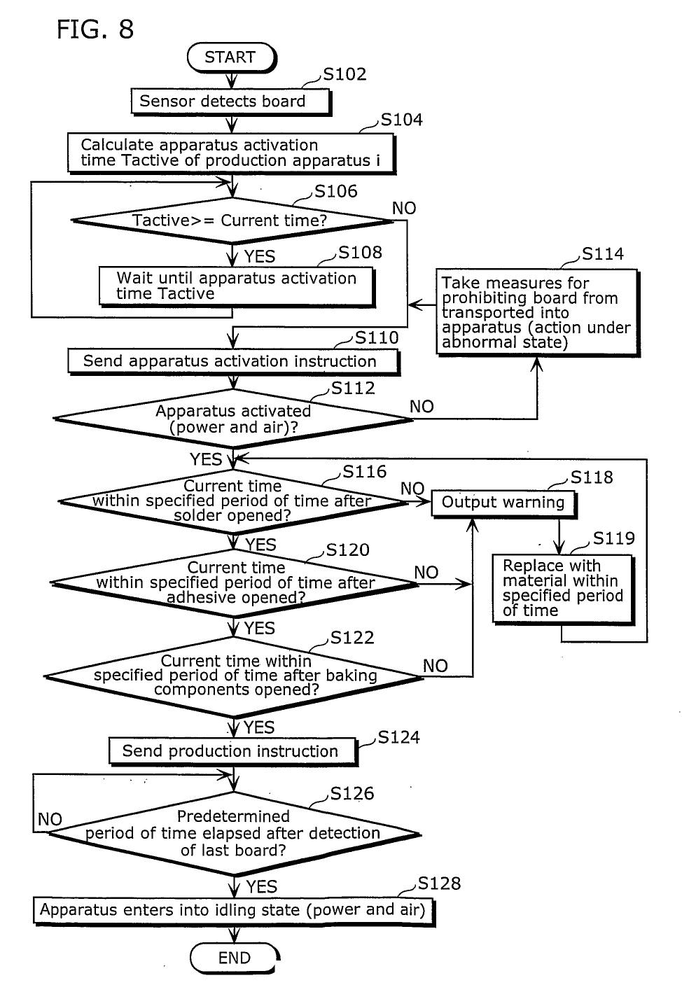

Next, referring to FIG. 7 and FIG. 8, a description is given of processes performed by the line manager 112.

Note that the following seven points are defined as preconditions for the processes of the line manager 112:

1) a time Tair shall be previously defined as a period of time from when each production apparatus receives an apparatus activation instruction to when its air pressure rises and the production apparatus enters a stable state;

2) a time TPower shall be previously defined as a period of time from when each production apparatus receives an apparatus activation instruction to when its power state becomes stable;

3) the sensors 176 equipped to the respective conveyors 118 and 126 shall all be managed by the line manager 112;

4) the moving speed of the conveyors 118 and 126 shall be constant at all times, and the line manager 112 shall have a grasp of such speed;

5) the line manager 112 shall be able to have a grasp of a cycle tact time Tcycle(i) of each production apparatus i;

6) a time Twait shall be previously defined as a period of time from when there becomes no board to be transported to when each production apparatus enters an idling state; and

7) the line manager 112 shall be able to have a grasp of the following times: solder supply time that is the time at which solder should be supplied to the solder printer 116; adhesive supply time that is the time at which adhesive should be supplied to the adhesive dispenser 120; component supply time that is the time at which components that require baking should be supplied to the mounters 122 and 124. Furthermore, a specified time, which is the expiration period of each of solder, adhesive, and components, shall be previously defined, and the line manager 112 shall have a grasp of such time.

As shown in FIG. 7, the following description assumes that, when all production apparatuses are in a non-operating state, a first board 190 is transported into the solder printer 116, which is the second uppermost apparatus after the stocker 114, and that time at which such board 190 has been transported is T (hereinafter also referred to as “board transported time T”).

FIG. 8 is a flowchart showing processes performed by the line manager 112 on an arbitrary production apparatus i.

When a board is transported into the solder printer 116, the solder printer 116 sends a board incoming event to the line manager 112, and the operating status monitoring unit 144 of the line manager 112 detects that there is an incoming board (S102 in FIG. 8).

Upon detecting that there is an incoming board, the apparatus activation time calculation unit 148 calculates an apparatus activation time Tactive (i) of the production apparatus i (S104). The apparatus activation time Tactive (i) is the time at which the production apparatus i should be activated in the case where a board 190 has been transported into the production apparatus 1 at the board transported time T. The apparatus activation time Tactive (i) is determined through processes described below.

Here, focusing on the production apparatus n, a board arrival time Tarrive (n) that is the time at which the board 190 arrives at the production apparatus n, is determined using the following equation (1):

$$\begin{matrix}< Equation 1 > & \\ Tarrive ( n ) = T + {\sum }_{i = 1}^{n - 1} Tcycle ( i ) . & ( 1 )\end{matrix}$$

In other words, the board arrival time Tarrive (n) is obtained by adding, to the board transported time T, cycle tact times Tcycle (i) of the production apparatuses, from the production apparatus 1 to the production apparatus (n-1). However, if the production apparatus n is activated at the board arrival time Tarrive (n), the production operation cannot be carried out for the board 190 until its air pressure and power become stable, even when the board 190 arrives at the production apparatus n. For this reason, in order to start the production operation for the board 190 upon the arrival of the board 190, it is necessary to activate the production apparatus n prior to the arrival of the board 190. The apparatus activation time Tactive (n) is determined using the following equation (2):

<Equation 2>
Tactive(n)=Tarrive(n)−max(Tair, Tpower) (2)
where max(a, b) denotes the maximum values of a and b.

In other words, by causing the production apparatus n to operate prior to the board arrival time Tarrive (n) by the time max (Tair, Tpower), which is the period of time that is required until both the air pressure and power become stable, it is possible to start the production operation for the board 190 simultaneously with the transportation of the board 190 into the production apparatus n.

Next, the apparatus activation time calculation unit 148 checks whether or not the apparatus activation time Tactive (i) of the production apparatus i is later than the current time (S106).

In the case where there is time until the apparatus activation time Tactive (i) (YES in S106), the apparatus activation time calculation unit 148 waits until the apparatus activation time Tactive (i) (S108), and checks again whether or not the apparatus activation time Tactive (i) of the production apparatus i is later than the current time (S106).

In the case where the current time is already the apparatus activation time Tactive (i), the apparatus operation instruction unit 146 sends, to the production apparatus i, an apparatus activation instruction at the apparatus activation time Tactive (i) (S110). In the production apparatus i, which has received the apparatus activation instruction, the CPU 172 sends instructions about power on and about air pressure control to the power control unit 178 and the air control unit 182, respectively, so as to cause the production apparatus i to enter an operating state.

The operating status monitoring unit 144 checks whether or not the production apparatus i has been activated after the above-mentioned instructions are sent (S112). In the case where the production apparatus i has not been activated (NO in S112), the operating status monitoring unit 144 judges that the production apparatus i is under abnormal circumstances, and the stopper control instruction unit 142 manipulates the stopper 184 of the production apparatus i so as to send an instruction to stop any boards 190 from being transported into the production apparatus i (S114). After this, the process of sending an apparatus activation instruction (S110) is performed again.

Meanwhile, in the case where the production apparatus i has been activated normally (YES in S112), the specified time verification unit 150 checks whether or not the current time is within the specified period of time after the package of the solder used by the solder printer 116 was opened (S116). In the case where the solder is used beyond the specified period of time (NO in S116), the warning output unit 152 causes the display unit 158 to display a warning such as “Please replace solder” (S118).

Furthermore, the specified time verification unit 150 checks whether or not the current time is within the specified period of time after the package of the adhesive used by the adhesive dispenser 120 was opened (S120). In the case where the adhesive is used beyond the specified period of time (NO in S120), the warning output unit 152 causes the display unit 158 to display a warning such as “Please replace adhesive” (S118).

Furthermore, the specified time verification unit 150 checks whether or not the current time is within the specified period of time after the package of the components, used by the mounter 122 or 124, that require baking, was opened (S122). In the case where the components are used beyond the specified period of time (NO in S122), the warning output unit 152 causes the display unit 158 to display a warning such as “Please replace BGA components” (S118).

After the process of outputting the warning (S118), the operator replaces the solder/adhesive/baking components being used beyond the specified period of time with one(s) within the specified period time (S119). After the replacement, the process of S116 and thereafter are carried out again.

In the case where the solder, adhesive, and baking components are all within the specified period of time (YES in S116, YES in S120, and YES in S122), the production instruction unit 154 sends an instruction to start the production operation to the production apparatus i (S124). In response to such instruction, the production apparatus i starts the production operation.

Next, the operating status monitoring unit 144 judges whether or not a predetermined period of time has elapsed after the last board 190 is detected to be transported out from each production apparatus (S126). In the case where the predetermined period of time has not elapsed (NO in S126), the operating status monitoring unit 144 waits until the predetermined period of time elapses, whereas in the case where the predetermined period of time has elapsed (YES in S126), the apparatus activation instruction unit 146 sends, to the production apparatus i, an instruction to cause the production apparatus i, which has gone through the specified period of time, to enter an idling state (S128). In response to this instruction, the CPU 172 of the production apparatus i instructs the power control unit 178 to stop supplying power to the axis control monitors 188 and instructs the air control unit 182 to stop the air from coming into and from the production apparatus i.

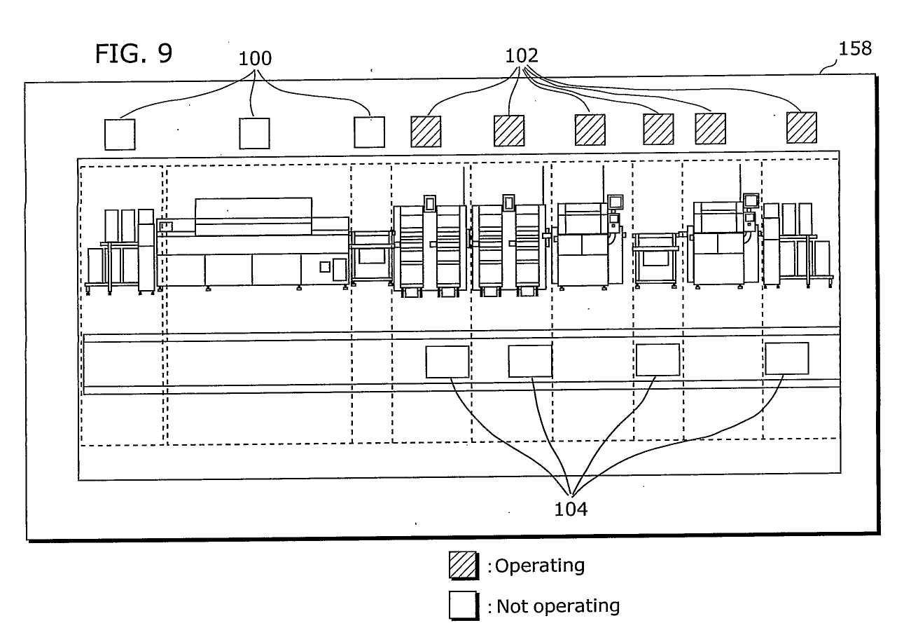

Note that the line status display unit 151 of the line manager 112 causes the display unit 158 to display a screen as shown in FIG. 9. In other words, a screen displayed by the display unit 158 shows the operating status of the production line at a glance. The following are shown on the screen: an external view of the production line; an icon 102 indicating that a production apparatus is in an operating state; an icon 100 indicating that a production apparatus is in a non-operating state; and an icon 104 indicating the position of a board.

As described above, in the component mounting system 110 according to the second embodiment of the present invention, the line manager 112 monitors whether each of the production apparatuses is in an operating state or in an non-operating state, i.e., the presence/absence of a board for which the production operation should be carried out, so that it is possible to operate each of the production apparatuses only when it is required. This structure makes it possible to promote energy saving.

Furthermore, the production apparatuses are caused to operate at the timing at which the respective production apparatuses become stable upon arrival of a board. Accordingly, there does not occur a problem that the production operation cannot be started although a board has arrived. This structure makes it possible to promote energy saving without reducing the production efficiency.

Furthermore, since the management of the expiration dates of solder, adhesive, and BGAs are carried out automatically, it is possible to prevent the occurrence of quality degradation of component mounting boards.

It should be noted that although the present invention has been described based on the component mounting system of the second embodiment, the present invention is not limited to the second embodiment.

For example, instead of making a judgment to cause a production apparatus to enter an idling state (S126 in FIG. 8), the production apparatus may be caused to enter an idling state based on a predetermined production planning. To be more specific, a production apparatus may be caused to enter an idling state in the case where the value indicating a time interval exceeds a reference value, the time interval indicating a time period between the completion of the production of a board type A and the start of the production of a board type B that is scheduled to be produced next in the production planning. Furthermore, in the case where a certain production apparatus in the production line has entered a maintenance state, the production apparatuses at the subsequent stages may be caused to enter an idling state.

Moreover, each production apparatus making up the production line (e.g., the mounter 122) may have the function of the line manager 112.

Furthermore, the present invention may have a structure in which information displayed on the display unit 158 of the line manager 112 may be displayed on the display unit of each production apparatus making up the production line. The present invention may also have a structure in which the line manager 112 can be remotely manipulated, using a manipulation unit or the like of each production apparatus.

Furthermore, in the above-described second embodiment, although the line manager 112 sends an apparatus activation instruction to a production apparatus (S110 in FIG. 8), and the production apparatus, which has received such apparatus activation instruction, enters an operating state on its own, it is also possible that the line manager 112 controls the display unit of such production apparatus to display the details of the apparatus activation instruction. The details of the apparatus activation instruction include, in addition to an instruction “activate the production apparatus”, its activation time or activation timing, or the like. Note that the details of an apparatus activation instruction may be displayed on the display unit of the line manager 112 or on the display unit of a mobile terminal device used by the operator.

### Third Embodiment

Next, a description is given of the component mounting system according to the third embodiment of the present invention. The third embodiment provides a more concrete description of the component mounting system described in the first embodiment.

The following describes the component mounting system according to the third embodiment of the present invention with reference to the drawings.

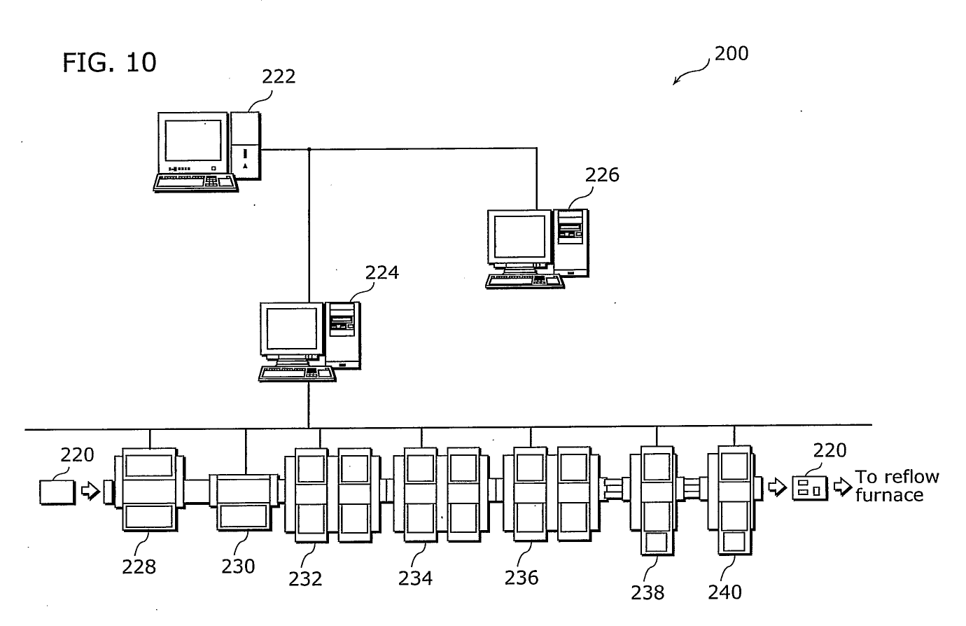

FIG. 10 is an external view showing an overall structure of the component mounting system of the third embodiment.

The component mounting system 200 is a system for mounting electronic components onto a board 220 and for determining an order of replacing materials required for component mounting when an advance notice indicating depletion of such materials is received. The component mounting system 200 is comprised of a solder printer 228, an adhesive dispenser 230, mounters 232 to 240, a material replacement order determination apparatus 222, an information collection apparatus 224, and an information output apparatus 226.

The material replacement order determination apparatus 222, information collection apparatus 224, and information output apparatus 226 correspond to the line manager 112 according to the first embodiment described with reference to FIG. 2.

The material replacement order determination apparatus 222 corresponds to the operating status monitoring unit 144, apparatus control instruction unit 302, and line status display unit 151 of the line manager 112. The information collection apparatus 224 corresponds to the communication unit 156 of the line manager 112. The information output apparatus 226 corresponds to the display unit 158.

The solder printer 228 is an apparatus that prints solder paste onto a board 220. The adhesive dispenser 230 is an apparatus that applies adhesive onto the board 220.

Each of the mounters 232 to 236 is an apparatus that mounts electronic components onto a board 220. Each of the mounters 232 to 236 mounts, onto a board 220, microchip components such as 0603 chip components (components sized 0.6 mm by 0.3 mm) at high speed using a modular type head. Each of the mounters 238 and 240 is an apparatus that mounts electronic components onto a board 220. A pickup nozzle of various type can be attached to/detached from the modular type head of each of the mounters 238 and 240, thereby enabling various types of components to be mounted onto boards 220. Note, however, that the mounters may be rotary type mounters that mount components using a rotary head rotating at high speed.

A board 220 is transported first from the solder printer 228, and then to the adhesive dispenser 230, and the mounters 232 to 240 in this order. After this, the board 220 is transported into a reflow furnace (not illustrated in the drawing), where the components mounted on the board 220 are fixed.

The information collection apparatus 224, which is connected to the solder printer 228, adhesive dispenser 230, and mounters 232 to 240 over a network, is an apparatus that collects pieces of information respectively indicating: the remaining amount of solder consumed by the solder printer 228; the remaining amount of adhesive consumed by the adhesive dispenser 230; and the remaining number of components consumed by each of the mounters 232 to 240.

The material replacement order determination apparatus 222 is an apparatus whose operations include: determining timing for giving an advance notice indicating material depletion based on the respective pieces of information, collected by the information collection apparatus 224, indicating the remaining amount/number of solder, adhesive, and components, i.e., materials; determining an order of replacing each type of materials; and the like. Note that solder, adhesive and components are mere examples, and thus the information collection apparatus 224 may also collect information about any other materials required for producing component mounting boards.

The information output apparatus 226 is an apparatus that displays an advance notice indicating material depletion and a material replacement order.

The information collection apparatus 224, material replacement order determination apparatus 222, and information output apparatus 226 are each constructed as an ordinary computer.

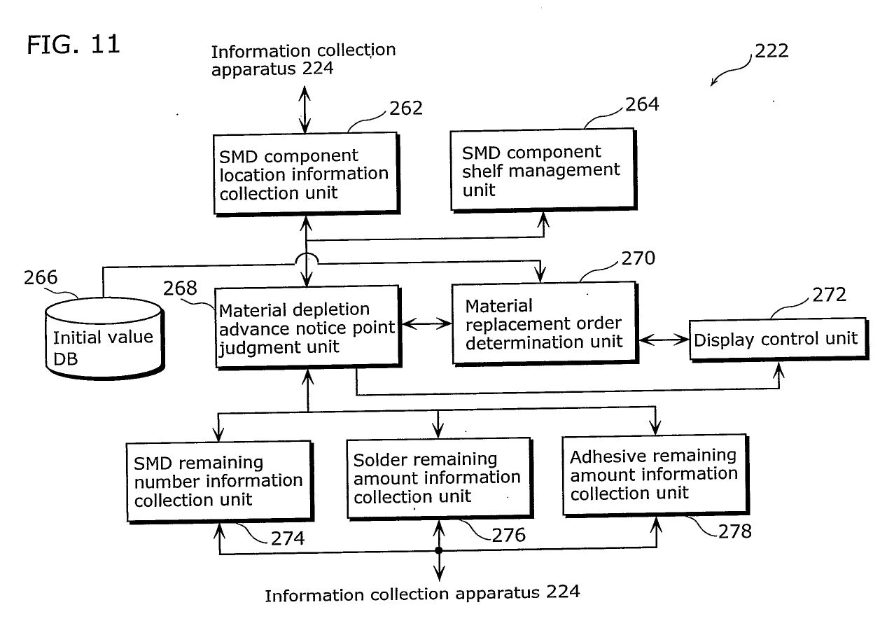

FIG. 11 is a block diagram showing an internal structure of the material replacement order determination apparatus 222.

The material replacement order determination apparatus 222 includes a surface mounting device (SMD) remaining number information collection unit 274, a solder remaining amount information collection unit 276, an adhesive remaining amount information collection unit 278, an initial value database (DB) 266, a material depletion advance notice point judgment unit 268, a material replacement order determination unit 270, a display control unit 272, an SMD component location information collection unit 262, and an SMD component shelf management unit 264.

The SMD remaining number information collection unit 274 is a processing unit that collects, via the information collection apparatus 224, the remaining number of SMD components to be mounted onto a board 220, such as chip components, quad Flat packages (QFD), and small outline packages (SOP).

The solder remaining amount information collection unit 276 is a processing unit that collects, via the information collection apparatus 224, the remaining amount of solder to be printed onto the board 220.

The adhesive remaining amount information collection unit 278 is a processing unit that collects, via the information collection apparatus 224, the remaining amount of adhesive to be applied onto the board 220.

The SMD component location information collection unit 262 is a processing unit that collects, via the information collection apparatus 224, information indicating the positions of the respective mounters 232 to 240 by which SMD components are mounted, on a component type basis.

The SMD component shelf management unit 264 is a processing unit that manages the respective shelves in which the SMD components are stored.

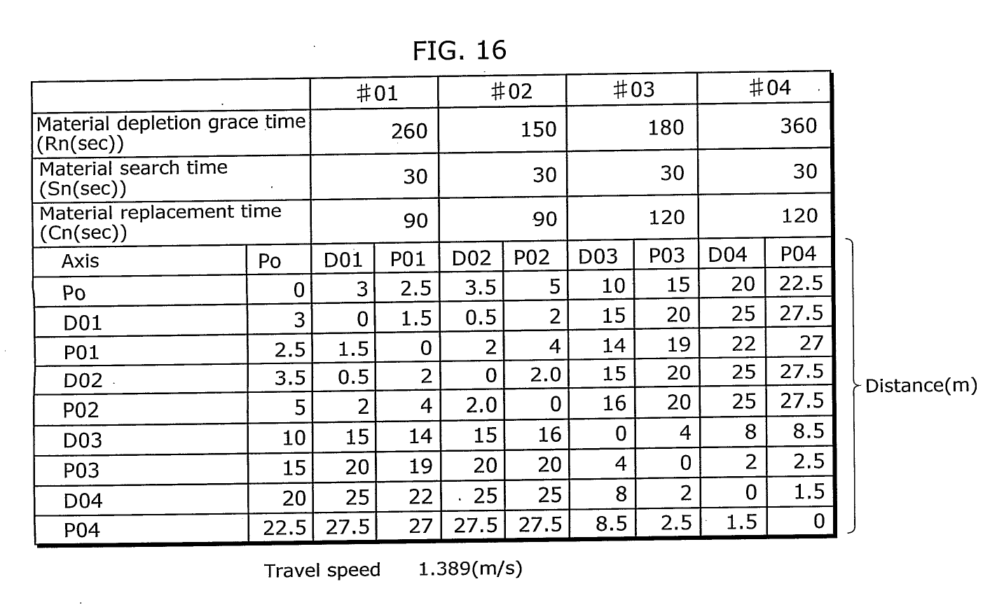

The initial value DB 266 is a database that stores a table, shown in FIG. 16 described below, indicating time and travel distance required for material replacement.

The material depletion advance notice point judgment unit 268 is a processing unit that judges a point where an advance notice indicating material depletion has occurred, based on the respective pieces of information collected by the SMD component location information collection unit 262, the SMD remaining number information collection unit 274, the solder remaining amount information collection unit 276, and the adhesive remaining amount information collection unit 278.

The material replacement order determination unit 270 is a processing unit that determines a material replacement order that allows materials to be replaced in the shortest time at the point judged by the material depletion advance notice point judgment unit 268 as being a point where an advance notice indicating material depletion has occurred.

The display control unit 272 is a processing unit that causes the information output apparatus 226 to display the material replacement order determined by the material replacement order determination unit 270.

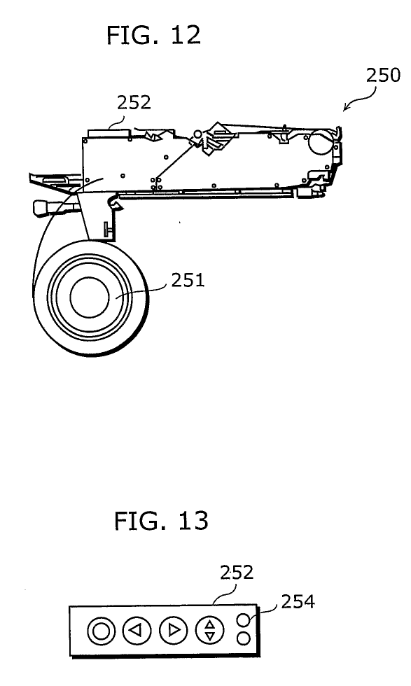

FIG. 12 is a diagram showing an example of a component feeder that holds a type of components mounted by each of the mounters 232 to 240. The component feeder 250 is connected to a reel 251 around which a component tape that holds components is wound. Mounting of the components is carried out while the component tape wound around the reel 251 is fed to inside each of the mounters. When the remaining number of the taped components is near depletion, an operation called “splicing” to connect a new component tape is carried out, thereby enabling the replacement of component tapes to be carried out without stopping the operation of the mounter.

The component feeder 250 has an operation panel 252 for: displaying the remaining amount or the like of a component tape; notifying a mounter, to which the component feeder 250 is attached, of the necessity to replace component tapes; and the like.

FIG. 13 is a diagram showing an example of the operation panel 252. The operation panel 252 includes a light emitting diode (LED) 54 or the like for notifying that the remaining number of components is near depletion.

The following describes a method of determining a material replacement order.

There are various points to be noted for efficiently replacing materials.

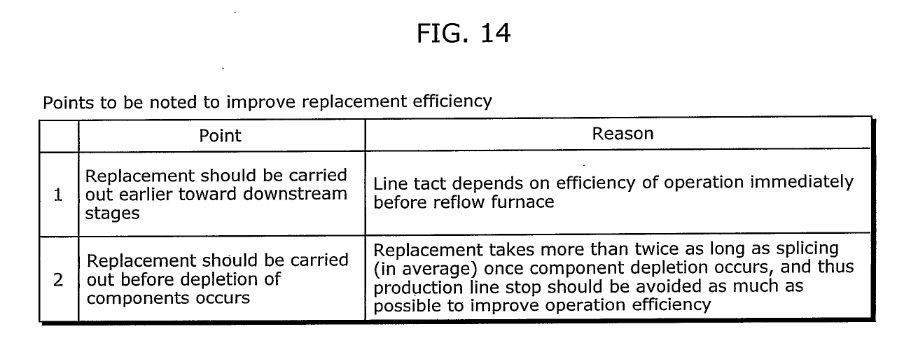

FIG. 14 is a table that summarizes points to be noted to improve the efficiency of material replacement.

As shown in FIG. 14, a first point to be noted is that material replacement should be carried out earlier toward downstream stages. This is because the line tact time depends on the tact time of the reflow furnace. In other words, the line tact time cannot be made shorter than the tact time of the reflow furnace. It is therefore necessary that the soldering of boards is always carried out in the reflow furnace. In order to allow this, it is impossible to stop the operation of an apparatus, which constitutes the production line, located immediately prior to the reflow furnace (e.g., mounter).

A second point to be noted is that a component tape wound around the reel 251 should be replaced by a new one before the depletion of taped components. Here, replacement of a component tape with a new one is known as “splicing” in which the trailing edge of a component tape near depletion is connected to a new component tape, and the currently used reel 251 is replaced by a reel 251 wound with such new component tape. This is necessary since the component tape should be replaced together with the reel 251 as a whole once component depletion has occurred, which takes more than twice as long, in average, as the time required for splicing in which the current component tape is connected to a component tape holding new components.

In the present embodiment, a material replacement order in the production line is determined using the Vehicle Routing Problem (VRP), which is a kind of the delivery routing problems.

The following five conditions (Condition 1 to Condition 5) should be adhered to as fixed preconditions for the VRP:

(Condition 1) each operator shall return to the point from which such operator departs (hereinafter referred to as the “reference point”) without fail;

(Condition 2) it shall be one operator who delivers material(s) to a point where material depletion has occurred (hereinafter also referred to as a “depletion occurrence point”);

(Condition 3) each operator shall be allowed to deliver materials to plural depletion occurrence points;

(Condition 4) necessary amount/number of materials shall be delivered to a depletion occurrence point without fail; and

(Condition 5) there shall be a cap on the amount/number of materials that each operator can deliver at one time.

In addition, Condition 6 described below is used as a modifiable precondition.

(Condition 6) the number of material storage sites shall be determined before applying the VRP, and it may be one or more sites.

The following description assumes that the number of material storage sites corresponding to Condition 6 is plural, and that the number of operators is one for simplification purposes.

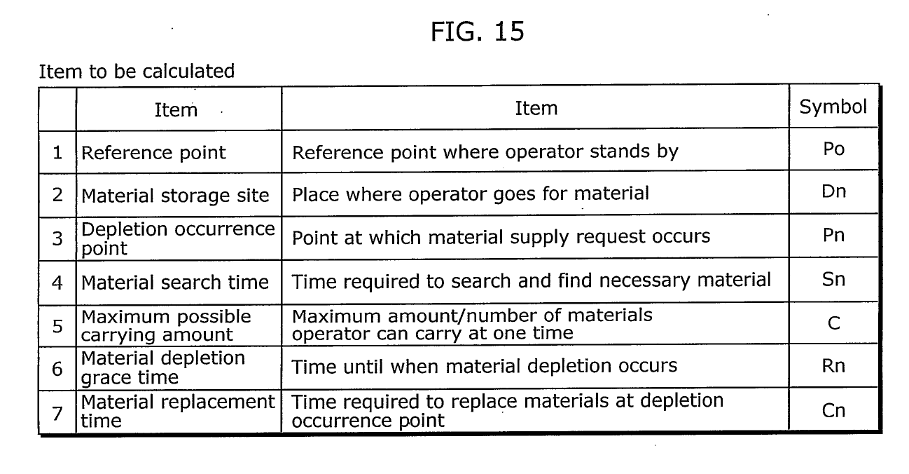

FIG. 15 is a table that summarizes various points used in processes described below and symbols indicating the same.

“Reference point” indicates a reference point at which the operator stands by, and is represented by the symbol “Po”.

“Material storage site” is a location where material(s) for replacement are placed, i.e., a location to which the operator goes for material(s). Note that in the case where a difference in material types is indicated by “n”, the material storage site is represented by the symbol “Dn”. The following description also assumes that the symbol “n” indicates a difference in material type.

“Depletion occurrence point” indicates a point for which an advance notice indicating material depletion, i.e., a request for material supply, occurs. “Depletion occurrence point” is represented by the symbol “Pn”.

“Material search time” indicates the time required by the operator to search and find intended material(s) at a material storage site, and is represented by the symbol “Sn”.

“Maximum possible carrying amount” indicates the maximum amount/number of materials the operator can carry at one time, and is represented by the symbol “C”.

“Material depletion grace time” indicates the time from when an advance notice indicating material depletion is given to when the depletion of material(s) actually occurs, and is represented by the symbol “Rn”.

“Material replacement time” indicates the time required to replace materials at a depletion occurrence point, and is represented by the symbol “Cn”.

FIG. 16 is a table showing the time and travel distance required for material replacement on a material type basis.

Focusing on the material type 01 (n=01) as an example, the table shows that the material depletion grace time R01 is 260 seconds, the material search time S01 is 30 seconds, and the material replacement time C01 is 90 seconds. It is assumed in FIG. 16 that “#n” indicates a material type number.

The table also shows that the distance from the reference point Po to the material storage site D01 is 3 m, and similarly that the distance from the reference point Po to the depletion occurrence point P01 is 2.5 m.

Here, assuming that the travel speed of the operator is 1.389 (m/second), the time required to travel from the reference point Po to the material storage site D01 is 2.2 seconds (=3 m/1.389 (m/seconds)).

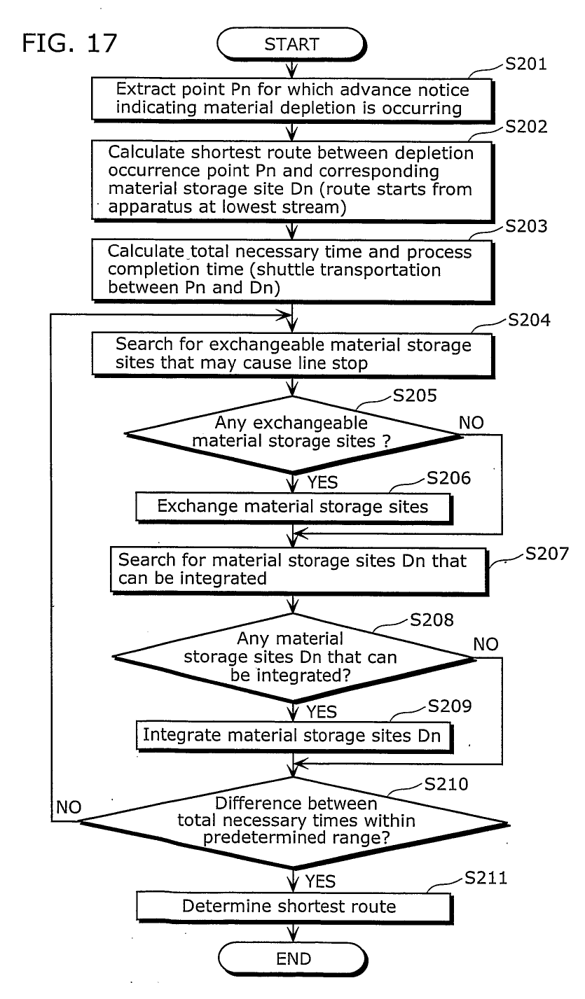

Taking a particular case, the following describes each of the processes performed by the material replacement order determination apparatus 222. FIG. 17 is a flowchart showing the processes of determining a material replacement order.

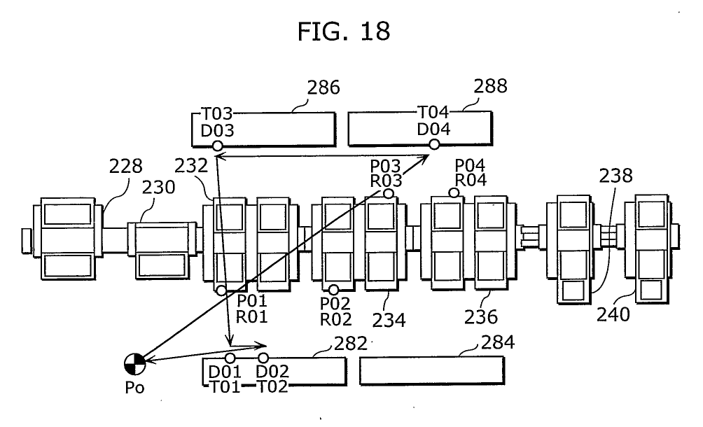

First, the material depletion advance notice point judgment unit 268 extracts all of the current depletion occurrence points Pn based on the respective pieces of information outputted from the SMD component location information collection unit 262, SMD remaining number information collection unit 274, solder remaining amount information collection unit 276, and adhesive remaining amount information collection unit 278 (S201). Here, as shown in FIG. 18, it is assumed that four depletion occurrence points P01 to P04 are extracted.

Next, the material replacement order determination unit 270 selects material storage sites Dn which correspond to the respective depletion occurrence points Pn, i.e., the material storage sites Dn where material(s) to be supplied to the respective depletion occurrence points Pn are located, and calculates the shortest route in which the distance between each two material storage sites Dn is the shortest (S202). Here, as shown in FIG. 18, four material storage sites D01 to D04 are selected. Considering the first point to be noted described with reference to FIG. 14, such selection is made on the precondition that the operator first travels to the material storage site Dn which corresponds to the depletion occurrence point Pn located at the lowest stream. The shortest route can be determined using, for example, a traveling salesman problem. In this case, taking that towns to which the salesman is to travel are the material storage sites Dn except for the reference point Po, and that a distance between towns (i.e., cost in the traveling salesman problem) is a travel distance between each two material storage sites Dn, the shortest route is determined so that a total distance the salesman needs to travel is the shortest. A route with the smallest total travel time may be determined, taking that travel time for traveling between each two towns is one cost.

The operator first travels to the material storage site Dn which corresponds to the depletion occurrence point Pn located at the lowest stream, and then travels to the subsequent depletion occurrence points according to the route determined by use of the traveling salesman problem. After arriving at the last material storage site Dn, the operator can follow the shortest route by returning to the reference point Po. Thus, in an example shown in FIG. 18, the operator departs from the reference point Po first, and travels to the material storage site D04 which corresponds to the depletion occurrence point P04 located at the lowest stream. Then, the operator travels to the material storage sites D03, D01, and D02 in this order, and finally returns to the reference point Po.

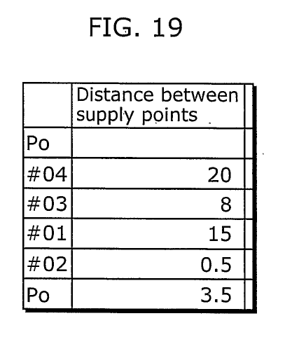

As shown in FIG. 19, the respective travel distances of the operator are as follows: 20 m from the reference point Po to the material storage site D04; 8 m from the material storage site D04 to the material storage site D03; 15 m from the material storage site D03 to the material storage site D01; 0.5 m from the material storage site D01 to the material storage site D02; and 3.5 m from the material storage site D02 to the reference point Po. Thus, 47 m, which is a total of these distances, is the shortest travel distance for the operator.

It should be understood, of course, that the operator supplies material(s) to the corresponding depletion occurrence point Pn when traveling to the material storage site Dn. For example, when heading to the material storage site D03, the operator supplies material(s) at the depletion occurrence point P03 when arriving at the material storage site D03, and then heads to the next material storage site D01.

Through the above processes, an initial solution to the material replacement order has been determined. The subsequent processes use the VRP to determine a material replacement order.

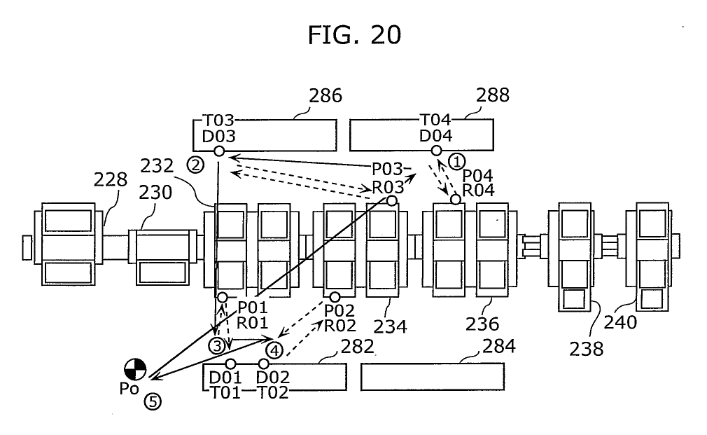

The material replacement order determination unit 270 determines, based on the initial solution determined in the process of calculating the shortest route (S202), (1) a total necessary time required for the operator to deliver material(s) to all depletion occurrence points Pn and complete the material replacement, and (2) time at which a material replacement process completes at each depletion occurrence point Pn (hereinafter referred to as a “process completion time”) (S203). At this time, the material replacement order determination unit 270 determines the total necessary time and each process completion time (S203), based on the shortest route to travel the material storage sites Dn determined in the process of calculating the shortest route (S202) and on that the shuttle transport is to be carried out between each material storage site Dn and the corresponding depletion occurrence point Pn. Note that a process completion time is the time that is determined taking that 0 is the time at which the operator starts material replacement. In other words, as shown in FIG. 20, the operator departs from the reference point Po to travel to the material storage site D04, where the operator takes out material(s), then travels to the depletion occurrence point P04, where the operator supplies the material(s), and returns to the material storage site D04. Next, the operator travels to the material storage site D03, and performs the same processes. The operator performs the same shuttle transportation for the material types numbered #1 and #2, after which the operator finally returns to the reference point Po. Note that broken line arrows in FIG. 20 indicate the shuttle transportation of materials.

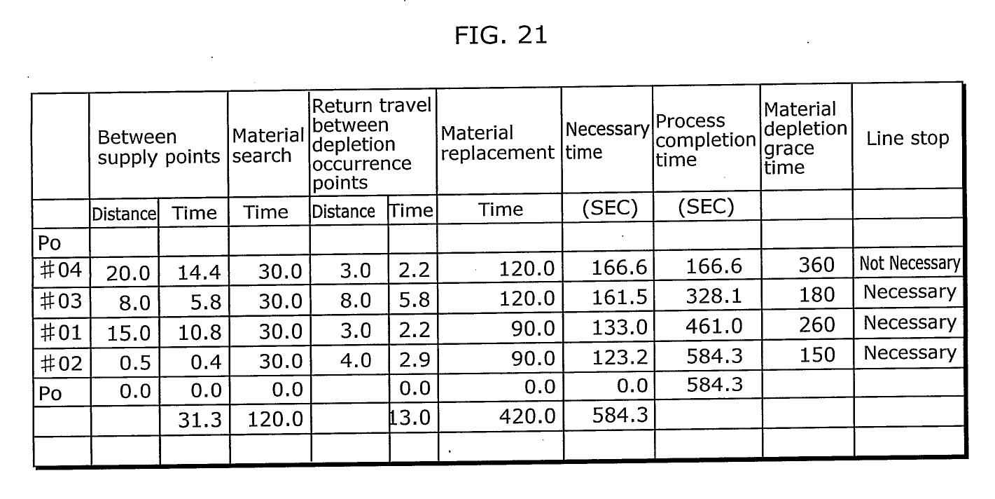

FIG. 21 is a table that summarizes a total necessary time and process completion times required for the shuttle transportation.

The first column from the left indicates the order of traveling the reference point Po and the material storage sites Dn determined in the above-described process of calculating the shortest route (S202). The second column indicates a travel distance between the reference point Po and each material storage site Dn in the travel order indicated in the first column. The third column indicates each travel time obtained by calculating, in terms of time, each travel distance indicated in the second column.

The fourth column indicates a component search time Sn that is the time required to search and find a required type of material(s) in each material storage site Dn. The fifth column indicates a return travel distance for traveling between each material storage site Dn and the corresponding depletion occurrence point Pn. The sixth column indicates each travel time obtained by calculating, in terms of time, each travel distance indicated in the fifth column. The seventh column indicates a material replacement time Cn required to be spent in each depletion occurrence point Pn.

The eighth column indicates a necessary time required to complete material replacement at each depletion occurrence point Pn, i.e., a sum of the following: a travel time indicated in the third column; a material search time Sn indicated in the fourth column; a travel time indicated in the sixth column; and a material replacement time Cn indicated in the seventh column.

The ninth column indicates a necessary time that is required until the completion of material replacement at each depletion occurrence point Pn, taking that the time at which the operator departs from the reference point Po is 0 second. In other words, the ninth column indicates an accumulative time obtained by accumulating the material replacement time of each depletion occurrence point Pn indicated in the eighth column. The tenth column indicates a material depletion grace time Rn that is a grace time before the depletion of each type of materials occurs.

The eleventh column indicates whether or not the production line should be stopped at the time of material replacement. More specifically, for a type of materials indicated by “Not necessary”, the production line is not stopped at the time of material replacement, and thus material replacement is possible without stopping the production line. On the other hand, for a type of materials indicated by “Necessary”, material replacement cannot be carried out without stopping the production line. In other words, when the result of comparing a process completion time indicated in the ninth column and a material depletion grace time indicated in the tenth column is that the process completion time comes earlier than the grace time, “Not necessary” is indicated, whereas “Necessary” is indicated otherwise.

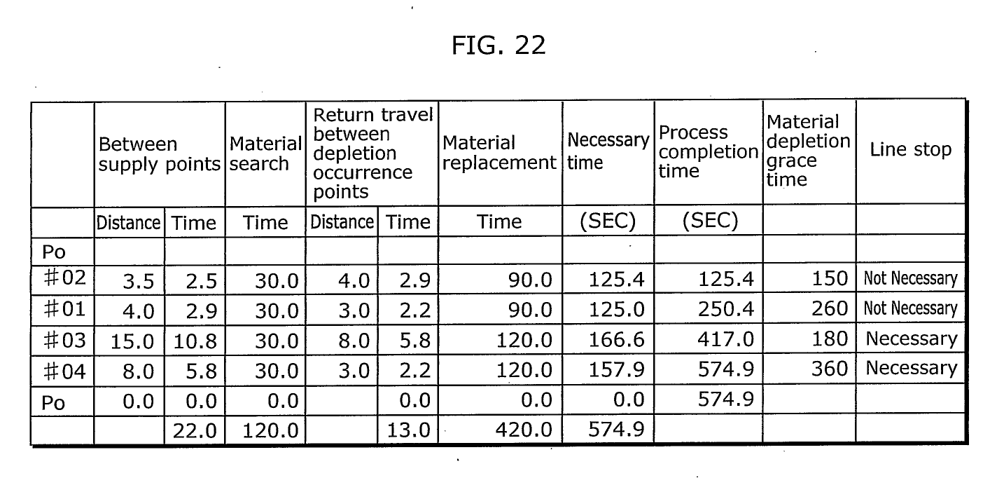

Next, the material replacement order determination unit 270 searches for exchangeable material storage sites that may cause line stop (hereinafter simply referred to as “exchangeable material storage sites) (S204). More specifically, the material replacement order determination unit 270 makes every possible travel order of traveling the material storage sites Dn by changing the order of the material storage sites Dn, and creates a table as shown in FIG. 22 for each of the resulting travel orders. The table shown in FIG. 22 should be viewed in the same manner as the one for viewing the table shown in FIG. 21. Based on the table shown in FIG. 22, the material replacement order determination unit 270 selects, from among all travel orders of traveling the material storage site Dn and depletion occurrence points Pn, a travel order that enables a largest number of types of materials to be replaced without stopping the production line (a travel order with the largest number of “Not necessary” in the column “Line stop”).

At this time, in the case where there are exchangeable material storage sites (YES in S205), such material storage sites are exchanged with each other (S206). The case where “there are exchangeable material storage sites” refers to the case where the travel order determined in the process of S204 includes a larger number of types of materials for which material replacement is possible without stopping the production line, than the original travel order before change. In such case, the material replacement order determination unit 270 changes the travel order of the material storage sites Dn.

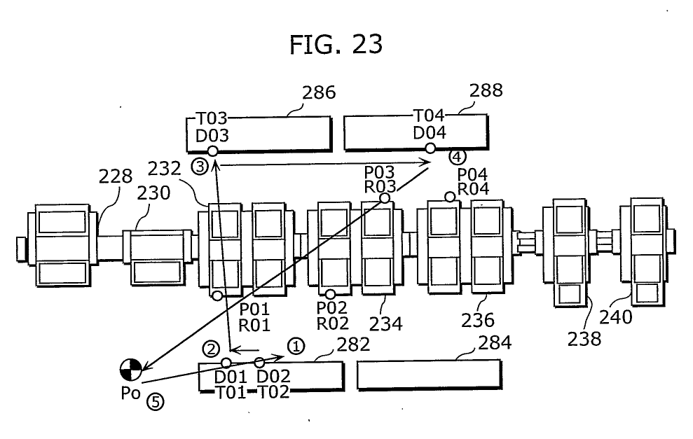

It is shown that the number of “Not necessary” indicated in the column “Line stop” in FIG. 22, for example, has increased to two from one after the above exchange process (S206), compared to the number shown in the table in FIG. 21. It is also shown that a total necessary time is a little shortened (574.9 seconds) compared with a total necessary time shown in FIG. 21 (584.3 seconds). FIG. 23 is a diagram showing a material replacement order after the exchange process (S206). It is shown in the drawing that the operator departs from the reference point Po, travels to the material storage sites D02, D01, and D03 in this order, while supplying materials to the depletion occurrence points corresponding to the respective material storage sites, and then returns to the reference point Po.

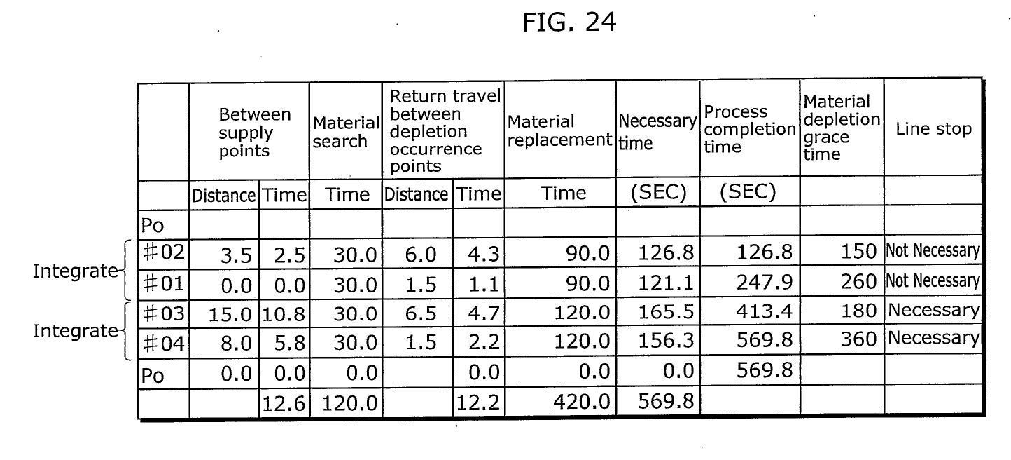

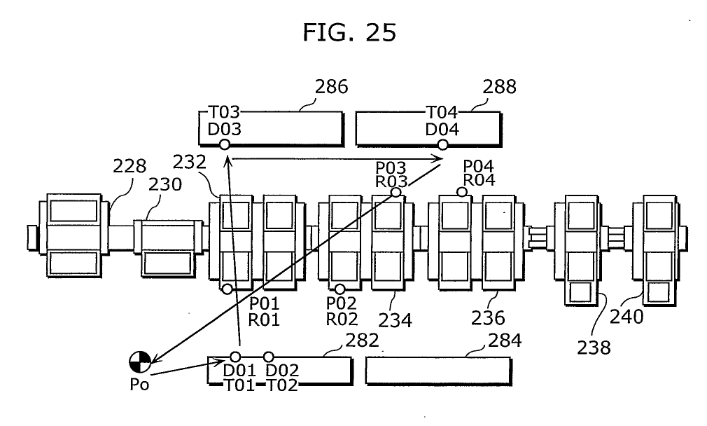

Next, the material replacement order determination unit 270 searches for material storage sites Dn that can be integrated to be handled as one material storage site (S207). The case where “material storage sites Dn can be integrated” refers to the case that satisfies the following: the distance between plural material storage sites Dn is not greater than a predetermined threshold value T1; and a total amount of materials to be carried from such plural material storage sites Dn is not greater than a maximum carrying amount C. Here, the material replacement order determination unit 270 makes every possible combination of material storage sites Dn that can be integrated, and creates a table as shown in FIG. 24 for each of the resulting travel orders after integration. Out of all the travel orders of the material storage sites Dn, the material replacement order determination unit 270 selects a travel order with the minimum total necessary time. The table shown in FIG. 24 should be viewed in the same manner as the one for viewing the tables shown in FIG. 21 and FIG. 22. Note that, out of the material storage sites Dn shown in FIG. 25, the material storage site D01 and the material storage site D02 are integrated, and the material storage site D03 and the material storage site D04 are integrated.

In the case where there are material storage sites Dn that can be integrated (YES in S208), the material replacement order determination unit 270 adopts a combination with the minimum total necessary time, from among the combinations, searched in the process of S207, of material storage sites Dn that can be integrated, and integrates the material storage sites Dn accordingly (S209). FIG. 24 shows an example of performing the integration. As a result of integrating material storage sites Dn in such manner, the operator takes out two or more types of materials from material storage sites Dn, and heads to the corresponding two or more depletion occurrence points Pn at one time to replace materials.

The material storage site D01 and the material storage site D02 are integrated as described above. Thus, since a travel distance from the material storage site D02 to the material storage site D01 is ignorable, the travel distance in the second column and the travel time in the third column corresponding to the material type numbered #01, are each 0. However, although the material storage site D03 and the material storage site D04 are integrated, the distance from the material storage site D03 to the material storage site D04 is not ignorable. For this reason, a normal travel distance and a normal travel time are given respectively as the travel distance in the second column and the travel time in the third column corresponding to the material type numbered #04, rather than giving the value of 0. Note that the judgment of whether or not the travel distance and travel time are ignorable is made based on whether or not the travel distance is not greater than a predetermined threshold value T2.

Here, a description is given of “return travel between depletion occurrence points” shown in the fifth column in FIG. 24. The material storage site D02 and the material storage site D01 are integrated. For this reason, the return travel distance “6.0” corresponding to the material type numbered #02 indicates a distance over which the operator travels from the material storage site D02 to the depletion occurrence point P02, and then to the depletion occurrence point P01. The return travel distance “1.5” corresponding to the material type numbered #01 indicates a distance over which the operator travels from the depletion occurrence point P01 to the material storage site D01. Such integration process results in a shorter total necessary time of 569.8 seconds as shown in FIG. 24 than the total necessary time of 574.9 seconds shown in FIG. 22.

The material replacement order determination unit 270 judges whether or not the difference between the two total necessary times has fallen within a predetermined range (S210). More specifically, the material replacement order determination unit 270 compares the total necessary times before and after the process of exchanging material storage sites Dn (S206) or the process of integrating material storage sites Dn, and judges that the difference between the two total necessary times has fallen within the predetermined range in the case where such difference indicated by the comparison is not greater than a predetermined threshold value (YES in S210), and determines that the material replacement order when the difference has fallen within the predetermined range is the shortest route (S211).

In the case where the difference has not fallen within the predetermined range (NO in S210), the material replacement order determination unit 270 repeats the process of searching for exchangeable material storage sites Dn (S204) and thereafter.

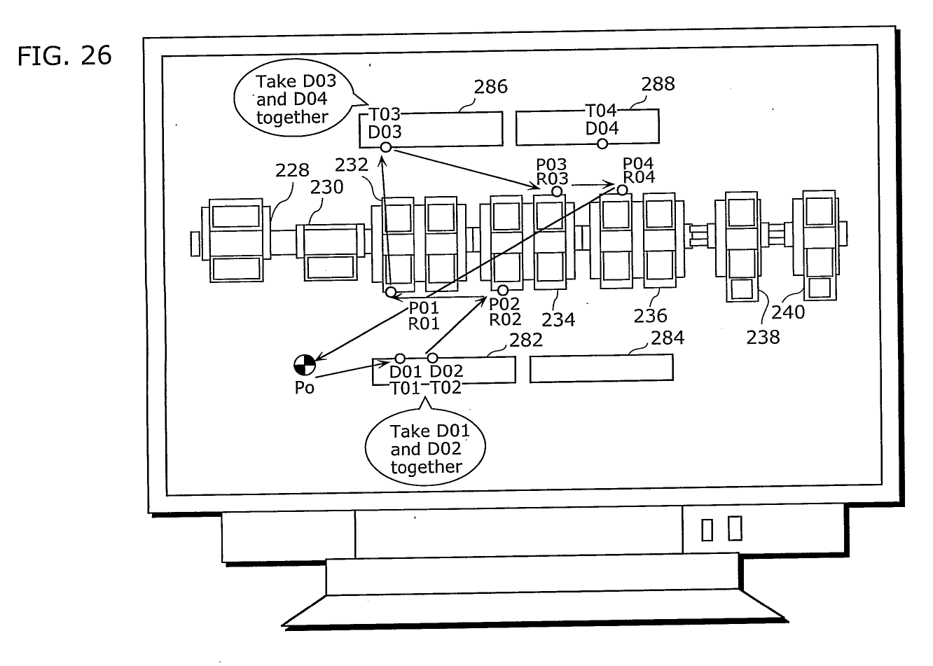

FIG. 26 is a diagram showing the final material replacement order to be displayed on the display of the information output apparatus 226. As shown in FIG. 26, an arrow indicates a travel route of the operator, and the message in a balloon indicates types of materials the operator should takes out at material storage sites Dn. Note that the operator can actually know the position of each depletion occurrence point Pn by the flashing of a warning lamp equipped to an apparatus such as a mounter and the flashing of the LED 54 of the operation panel 252 of the component feeder 250.

Note that the above display may be displayed by the display unit of a mobile terminal device used by the operator. In such case, the following options are possible: a route of the operator may be displayed based on a position of the operator, using the Global Positioning System (GPS); the mobile terminal device recognizes the history of material replacements and provides an instruction, on the screen thereof, indicating the next position the operator should head to; and the like.

Alternatively, the next position the operator should head to may be indicated, by previously equipping warning lamps to each depletion occurrence point and each material storage site, and by the material replacement order determination apparatus 222 flashing the warning lamp equipped to the next position to be traveled by the operator.

As described above, according to the third embodiment of the present invention, a material replacement order is determined by use of the VRP. This makes it possible to determine a material replacement order that enables material replacement to be carried out in the shortest time.

Furthermore, by performing the processes from S201 to S202 out of the processes shown in FIG. 17, it is possible to preferentially perform material replacement toward downstream stages in the production line. This facilitates the flow of operations into the reflow furnace.

Accordingly, it becomes possible to replace materials without stopping the production line as much as possible.

The component mounting system according to the present invention has been described based on the third embodiment, but the present invention is not limited to the third embodiment.

For example, the third embodiment is described using one operator, but there may be plural operators.

Furthermore, the traveling salesman problem has been used to determine the shortest route in the above-described process of calculating the shortest route to travel the material storage sites Dn (S202 in FIG. 17), the shortest route may be determined using any other methods.

Furthermore, in the above-described process of calculating the shortest route to travel the material storage site Dn (S202 in FIG. 17) in the third embodiment, an initial solution to the route along which the operator travels has been determined on the precondition that the operator first travels to the material storage site Dn corresponding to the depletion occurrence point Pn located at the lowest stream in the production line, but the route with the shortest necessary time may be determined also in the subsequent processes (S203 to S211 in FIG. 17) while maintaining such precondition that the operator first travels to the material storage site Dn corresponding to the depletion occurrence point Pn located at the lowest stream.

Alternatively, in the process of calculating the shortest route to travel the material storage sites Dn (S202 in FIG. 17), an initial solution to the route along which the operator will travel may be determined by ignoring the above precondition (that the operator first travels to the material storage site Dn corresponding to the depletion occurrence point Pn located at the lowest stream in the production line).

Moreover, each of production apparatus making up the production line (e.g., the mounter 232) may have the function of the material replacement order determination apparatus 222.

Furthermore, the present invention may have a structure in which information displayed on the display unit of the material replacement order determination apparatus 222 may be displayed on the display unit of each production apparatus making up the production line. The present invention may also have a structure in which the material replacement order determination apparatus 222 can be remotely manipulated, using a manipulation unit or the like of each production apparatus.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention is applicable for use as a monitoring apparatus or the like that monitors a production line including a mounter, a solder printer, an adhesive dispenser, and the like.

The present invention is also applicable for use as a method of determining a material replacement order in a production line, and particularly as a method or the like of determining a material replacement order in a production line for mounting electronic components onto a board.

1. A monitoring method of monitoring an operating status of a production line for producing a component mounting board by mounting components onto a board, said method comprising:
monitoring an operating status of each of production apparatuses making up the production line; and
performing a control that allows each of one or more mounters, included in the production apparatuses making up the production line, to efficiently produce the component mounting board, based on a result of said monitoring.

2. The monitoring method according to claim 1,
wherein in said monitoring, the operating status of at least one of the production apparatuses is monitored, and
said performing of the control includes
causing one or more of the mounters to enter an operating state or a non-operating state based on the result of said monitoring, each of one or more of the mounters being different from the production apparatus subjected to said monitoring.

3. The monitoring method according to claim 2,
wherein in said monitoring, it is detected whether or not the board has been transported into a predetermined one of the production apparatuses, and
in said causing, activation timing for activating a mounter of interest is determined so that the mounter of interest is in an operating state when the board arrives at the mounter of interest, the mounter of interest being included in the mounters and being located downstream of the predetermined production apparatus.

4. The mounting method according to claim 3,
wherein in said causing, the mounter of interest is further activated at the determined activation timing.

5. The monitoring method according to claim 3,
wherein in said causing, an instruction is further displayed or transmitted, the instruction being intended for activating the mounter of interest at the determined activation timing.

6. (canceled)

7. The monitoring method according to claim 2,
wherein in said monitoring, it is detected whether or not the board has been transported into a predetermined one of the production apparatuses, and
said causing includes:
obtaining a board incoming timing that is timing at which the board has been transported into the predetermined production apparatus;
determining activation timing for activating each mounter of interest so that each mounter of interest is in an operating state when the board arrives at each mounter of interest, based on the board incoming timing and a tact time of at least one of the production apparatuses that is located between each mounter of interest and the predetermined production apparatus, each mounter of interest being included in the mounters and being located downstream of the predetermined production apparatus; and
activating each mounter of interest at the determined activation timing.

8. The monitoring method according to claim 7,
wherein said determining of the activation timing includes:
calculating a board arrival timing that is timing at which the board arrives at each mounter of interest, based on the board incoming timing and the tact time of at least one of the production apparatuses that is located between each mounter of interest and the predetermined production apparatus; and
determining that timing earlier than the board arrival timing is the activation timing for activating each mounter of interest, the timing being earlier by a period of time from when each mounter of interest is activated to when each mounter of interest enters a stable state.

9-10. (canceled)

11. The monitoring method according to claim 2,
wherein in said monitoring, it is judged, for each of the mounters, whether or not a predetermined period of time has elapsed after the board is transported out from the mounter, and
in said causing, each of the mounters is caused to enter a non-operating state in the case where it is judged in said judging that the predetermined period of time has elapsed after the board is transported out from the mounter.

12-16. (canceled)

17. The monitoring method according to claim 1,
wherein said monitoring includes:
extracting a plurality of depletion occurrence points in the production line, each of the depletion occurrence points being a point for which an advance notice is given indicating that material depletion is approaching; and
identifying, from the depletion occurrence points, a lowest depletion occurrence point that is located at a lowest stream in the production line, and
said performing of the control includes
determining a material replacement order by determining a travel route that allows an operator to first arrive at a material storage site corresponding to the lowest depletion occurrence point, and then to travel the other depletion occurrence points and material storage sites corresponding to the respective depletion occurrence points, the material replacement order being an order in which the operator replaces materials at the respective depletion occurrence points while traveling along the determined travel route.

18. The monitoring method according to claim 17,
wherein in said determining of the material replacement order, the material replacement order is determined by determining the travel route with a shortest travel distance or a shortest travel time, the travel route allowing the operator to first arrive at the material storage site corresponding to the lowest depletion occurrence point, and then to travel the material storage sites corresponding to the respective depletion occurrence points.

19. The monitoring method according to claim 18,
wherein in said determining of the material replacement order, the material replacement order with a smallest total cost in the travel route is determined, the total cost being a sum of costs that are determined taking that a travel distance or a travel time between two arbitrary points out of the depletion occurrence points is one cost.

20. The monitoring method according to claim 18,
wherein in said determining of the material replacement order, the material replacement order is determined by determining the travel route with a shortest necessary time, the travel route allowing the operator to travel the depletion occurrence points and the material storage sites corresponding to the respective depletion occurrence points, and to supply the materials at the respective depletion occurrence points in the shortest time.

21-25. (canceled)

26. The monitoring method according to claim 1,
wherein said monitoring includes
extracting a plurality of depletion occurrence points in the production line, each of the depletion occurrence points being a point for which an advance notice is given indicating that material depletion is approaching, and
said performing of the control includes
determining a material replacement order by determining a travel route with a shortest necessary time, the travel order allowing an operator to travel the depletion occurrence points and material storage sites corresponding to the respective depletion occurrence points, and to supply materials at the respective depletion occurrence points in the shortest time, the material replacement order being an order in which the operator replaces the materials at the respective depletion occurrence points while traveling along the determined travel route.

27. A monitoring apparatus that monitors an operating status of a production line for producing a component mounting board by mounting components onto a board, said apparatus comprising:
a monitoring unit operable to monitor an operating status of each of production apparatuses making up the production line; and
a control unit operable to perform a control that allows each of one or more mounters, included in the production apparatuses making up the production line, to efficiently produce the component mounting board, based on a result of the monitoring performed by said monitoring unit.

28. The monitoring apparatus according to claim 27,
wherein said monitoring unit is operable to monitor the operating status of at least one of the production apparatuses, and
said control unit includes
an operation control unit operable to cause one or more of the mounters to enter an operating state or a non-operating state based on the result of the monitoring performed by said monitoring unit, each of one or more of the mounters being different from the production apparatus monitored by said monitoring unit.

29. The monitoring apparatus according to claim 27,
wherein said monitoring unit includes
an extraction unit operable to extract a plurality of depletion occurrence points in the production line, each of the depletion occurrence points being a point for which an advance notice is given indicating that material depletion is approaching, and
said control unit includes
a replacement order determination unit operable to determine a material replacement order by determining a travel route with a shortest necessary time, the travel order allowing an operator to travel the depletion occurrence points and material storage sites corresponding to the respective depletion occurrence points, and to supply materials at the respective depletion occurrence points in the shortest time, the material replacement order being an order in which the operator replaces the materials at the respective depletion occurrence points while traveling along the determined travel route.

30. (canceled)

31. A mounter that mounts components onto a board, said mounter comprising:
a monitoring unit operable to monitor an operating status of each of production apparatuses making up a production line for producing a component mounting board by mounting components onto a board; and
a control unit operable to perform a control that allows each of one or more mounters, included in the production apparatuses making up the production line, to efficiently produce the component mounting board, based on a result of the monitoring performed by said monitoring unit.

32. The mounter according to claim 31,
wherein said monitoring unit is operable to monitor the operating status of at least one of the production apparatuses making up the production line for producing the component mounting board, and
said control unit includes
an operation control unit operable to cause one or more of the mounters to enter an operating state or a non-operating state based on the result of the monitoring performed by said monitoring unit, each of one or more of the mounters being different from the production apparatus monitored by said monitoring unit.

33-34. (canceled)

35. The mounter according to claim 31,
wherein said monitoring unit includes
an extraction unit operable to extract a plurality of depletion occurrence points in-the production line including said mounter, each of the depletion occurrence points being a point for which an advance notice is given indicating that material depletion is approaching, and
said control unit includes
a replacement order determination unit operable to determine a material replacement order by determining a travel route with a shortest necessary time, the travel order allowing an operator to travel the depletion occurrence points and material storage sites corresponding to the respective depletion occurrence points, and to supply materials at the respective depletion occurrence points in the shortest time, the material replacement order being an order in which the operator replaces the materials at the respective depletion occurrence points while traveling along the determined travel route.

36. (canceled)

37. A program for monitoring an operating status of a production line for producing a component mounting board by mounting components onto a board, said program comprising:
monitoring an operating status of each of production apparatuses making up the production line; and
performing a control that allows each of one or more mounters, included in the production apparatuses making up the production line, to efficiently produce the component mounting board, based on a result of said monitoring.

38-39. (canceled)
